(19) United States
(12) Patent Application Publication
(10) Pub. No.: US 2009/0120361 A1
(43) Pub. Date: May 14, 2009

(54) Coating device for water-based lacquer that is dried by near-infrared light

(76) Inventor: Stefan Schiele, Niederzissen (DE)

Correspondence Address: FRIEDRICH KUEFFNER, 317 MADISON AVENUE, SUITE 910, NEW YORK, NY, 10017, US

(21) Appl. No.: 10/550,166

(22) PCT Filed: Mar. 22, 2004
(86) PCT No.: PCT/EP04/02971

§ 371 Date: Mar. 21, 2007

(30) Foreign Application Priority Data
Mar. 21, 2003 (DE) 203 04 641.2

(51) Int. Cl. B05B 5/025

(52) U.S. Cl. 118/641

(57) ABSTRACT

The invention relates to a coating device by means of which a water-soluble compound is applied to at least one edge of a moving oblong part and is dried by NIR light.

The present invention relates to a coating device by means of which a water-soluble compound is applied to at least one edge of moving elongated workpiece.

Nowadays there is an increasing requirement to coat the edges or parts of the edges of an elongated workpiece, for example, a parquet flooring board, with a compound, for example, a lacquer and/or an adhesive in continuously operating installations. In this case, the compound is preferably water-soluble in order to avoid negative influences on people and the environment.

It is thus the object of the present innovation to provide a coating device by means of which the water-soluble compounds can be applied to at least parts of the edge of a moving elongated workpiece and can be dried.

The object is solved according to the innovation by a coating device by means of which a water-soluble compound can be applied to at least parts of the edge of a moving elongated workpiece which has at least one device for applying the compound and at least one near infrared (NIR) drying device arranged thereafter in the direction of movement of the workpiece.

It was extremely astonishing and unexpected for the person skilled in that art that elongated workpieces, such as profiles made of wood, for example, parquet flooring boards, or plastic as well as single components, for example, cross-beams of a window can be coated with a water-soluble compound very efficiently and with a very high quality using the device according to the innovation. The device according to the innovation can be manufactured simply and inexpensively and has proved to be extremely robust in continuous operation. The water-soluble compound applied dries so rapidly using the NIR infrared drying that transport speeds of up to 100 m/min can be achieved for the workpiece to be coated.

NIR drying in the sense of the innovation is infrared drying where the radiation has a wavelength of 600-1400 nm, preferably 800-1200 nm.

The NIR drying preferably consists of a plurality of modules which can be aligned especially preferably with respect to the workpiece to be coated. Accordingly the NIR drying is preferably arranged so that it can be adjusted in height and/or tilted.

Furthermore, the drying modules are preferably regulated according to the application medium and/or the transport speed; that is, in the case of an application medium having a high water content and/or very high transport speeds, either a plurality of NIR drying modules arranged in the direction of travel of the workpiece are used and/or their intensity is regulated as a function of the water fraction and/or the transport speed. By means of this preferred embodiment of the innovation, it is possible to match the drying exactly to the given process.

Furthermore, the coating device according to the innovation preferably has cooling plates by means of which the workpiece to be coated or the conveyor belts used to transport the workpiece can be cooled to avoid these becoming too hot during drying.

Any application head known to the person skilled in the art is suitable for applying the water-soluble compound. However, the application head preferably has an application nozzle by means of which the water-soluble compound is applied to the edge to be coated. Furthermore, the application device preferably has a suction nozzle by which means excess coating material is extracted. Such coating heads are described, for example, in DE 42 07 090, WO 02/053296, WO 02/055215 and WO 02/055214. These patent applications are introduced herewith as reference and are thus valid as part of the disclosure.

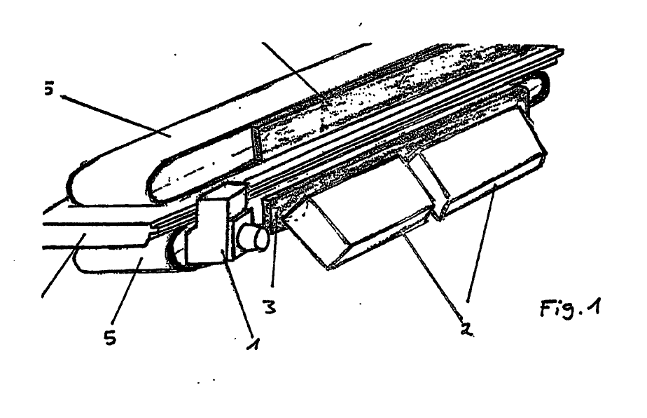

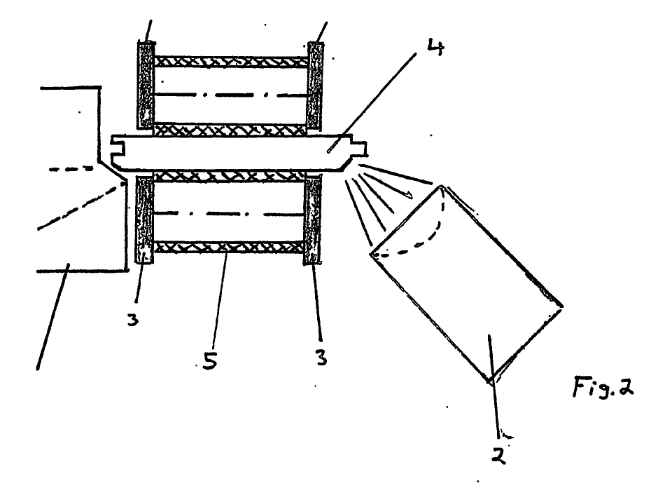

The innovation is explained hereinafter with reference to FIGS. 1 and 2. These explanations are merely examples and do not restrict the general idea of the innovation.

FIG. 1 shows a perspective view of the device according to the innovation and

FIG. 2 shows a front view of the device according to the innovation.

FIG. 1 show the device according to the innovation. A workpiece 4 whose edges are to be coated at least partly with a water-soluble compound, for example, a lacquer and/or an adhesive, passes through the device from left to right as indicated by the arrows. The workpiece 4 is transported by the continuous conveyor belts 5. The coating device according to the innovation has an application head 1 by which means the water-soluble compound is applied to the edge. This application head has a coating nozzle (not shown) which applies the water-soluble compound to the edge to be coated and a suction nozzle (not shown) by which means the excess material is extracted. The extraction nozzle is connected to a vacuum installation and a separator (each not shown). Furthermore, the device according to the innovation has two NIR drying modules located after the application head, which emit near-infrared radiation and thereby dry the coated edge. The drying modules 2 are arranged tiltably in the present example so that the radiation can be aligned as perpendicularly as possible to the surface to be dried. In order to avoid overheating of the conveyor belts 5 or the workpiece 4 transported thereon, lateral cooling plates 3 are provided.

The person skilled in the art recognizes that the application device 1, the near infrared emitter 2 and the cooling plates 3 can also be arranged on the other side of the conveyor belt.

FIG. 2 shows a front view of the device according to the innovation wherein on this occasion, the device according to this innovation has respectively one application device, cooling plates and an NIR drying module to the right and to the left of the workpiece to be coated. Shown on the left is the application device 1 which coats an edge of the workpiece 4 shown by a thicker line at the bottom using an application nozzle (not shown). The dashed lines show the suction channel which is connected to the suction nozzle (not shown) which extracts excess material from the coated edge. The NIR drying modules arranged thereafter on this side are covered by the coating device 1. On the right-hand side the coating device was omitted for reasons of clarity and merely the drying module 2 is shown which irradiates the coated surface at an angle obliquely from below in order to dry this. The device according to the innovation also has cooling plates 3 which especially protect the conveyor belts 5 used to transport the workpiece to be coated in the plane of the paper, from overheating.

1. A coating device by means of which a water-soluble compound is applied to at least parts of an edge of a moving elongated workpiece (4), characterised in that said device comprises at least one device (1) for applying a compound and at least one NIR drying module (2) arranged thereafter in the direction of movement of the workpiece.

2. The coating device according to claim 1, characterised in that the NIR drying consists of a plurality of modules.

3. The coating device according to any one of the preceding claims, characterised in that the NIR drying can be aligned, preferably can be adjusted in height and/or tilted.

4. The coating device according to claim 2, characterised in that the module can be regulated depending on the application medium and/or the transport speed.

5. The coating device according to any one of the preceding claims, characterised in that it comprises cooling plates (3).

6. The coating device according to any one of the preceding claims, characterised in that the device (1) comprises an application nozzle and a suction nozzle.
